(19) United States
(12) Patent Application Publication
(10) Pub. No.: US 2017/0240360 A1
(43) Pub. Date: Aug. 24, 2017

(54) LOADING TRAY DEVICE HAVING A MOVABLE FLOOR

(71) Applicant: MANUFACTURE A BESANCON (MAB), Besancon (FR)

(72) Inventor: Winfrid RAUCH, Pouilly Les Vignes (FR)

(21) Appl. No.: 15/504,619

(22) PCT Filed: Jul. 29, 2015
(86) PCT No.: PCT/FR15/52106

§ 371 Date: Feb. 16, 2017

(30) Foreign Application Priority Data
Aug. 27, 2014 (FR) 1458005

(51) Int. Cl. B65G 25/06

(52) U.S. Cl. CPC B65G 25/065

(57) ABSTRACT

A loading tray device having a movable floor includes a frame that receives a juxtaposition of at least one first blade and one second blade that are mounted so as to be movable in longitudinal translation. Each blade has a lower beam and a covering plate attached to the upper edges of side walls. The first and second walls respectively include a first flange and a second flange that extend laterally to and outside of the beam. The second wall of each blade has a height that is less than the height of the first wall by the thickness of the first flange, such that the first flange of the second blade abuts the second flange of the first blade.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention is related to the field of transport and handling of loads. In particular, but not exclusively, the invention relates to the tray of a vehicle intended to receive said load during loading and for its transport, as well as to ensure its unloading.

2. Description of Related Art Including Information Disclosed Under 37 CFR 1.97 and 37 CFR 1.98.

The present invention will find a preferred, but non-restrictive, application in the transport, storage and handling of loads in the form of bulk products, in particular various waste and refuse, but also, but not exhaustively, chips, sawdust, wood chips, cereals, rubble or gravel.

To this end, the invention relates to a loading tray device, preferably a ventilated device, having a movable floor.

Thus, such a tray can equip a transport vehicle, such as a truck, or a wagon, such as a trailer. This tray may be integrated as a bottom within a bucket, movable on a vehicle or fixed in the case of a stationary installation.

In a known way, the trucks are equipped with a tray, the bottom of which constitutes a floor intended to receive a load, namely in the form of bulk products. The unloading will generally occur through a tilting operation, by lifting at the front side of the said tray, the bulk products then being poured out through the opposite end, generally equipped with a door that is open when this operation is performed. Such a tray is often surrounded by walls, forming a bucket at the rear of the truck, or on a trailer-type wagon.

This tilting operation can present risks in the case of a floor having a considerable length, of about or larger than ten meters. Indeed, the lifting height can cause an imbalance of the vehicle and its tilting.

An alternative solution consists of tray devices having a movable floor. Such a floor is mounted in movement, in longitudinal translation, so as to permit the movement of the load towards the outside.

To this end, said movable floor is formed, over its width, of a juxtaposition of blades oriented longitudinally and parallel to each other. These blades are slidably mounted relative to each other, from a folded position forming the tray of the vehicle and ensuring the loading and transport of the load, into an extended position, in order to permit its unloading, and vice versa. In the extended position, the blades are partly cantilevered, protruding outwardly from the tray, projecting at the rear of the vehicle.

Such a movable floor is also used in the stationary installations in a way comparable to a conveyor belt.

Several blades are integral during their movement, forming groups. The latter are at least two, preferably three, in number. The blades of a first group are separated from each other by the blades of the second group, which may, in turn, be separated from each other by the blades of the third group. Thus, the simultaneous movement, from the folded position into the extended position, of all the groups permits to push the load supported by the floor towards one end of the tray, while the successive movement of the different groups of blades from the extended position towards the folded position permits the pouring of part of the load at said end of the tray and the maintaining of the remainder of the load in the position into which it has just been pushed.

This alternating movement technique, in order to permit the handling and/or the unloading of a load in the form of bulk products, confers to said movable floor a generic name of “moving bottom”.

Examples of such moving bottoms are described in U.S. Pat. No. 7,926,646 or U.S. Pat. No. 6,763,933.

In particular, each blade is in the form of a metal profile with a hollow cross-section having a generally rectangular shape. Each profile is slidably mounted according to a translational movement along and on one or two guide rails integral at their lower portion with the tray. The cross-section of the profiles is specific, so as to ensure the tightness at the level of the gap between two adjacent blades. This tightness is essential, especially in the case of pulverulent products, preventing the residues and particles from infiltrating into the gaps between the blades and to limit their movements relative to each other.

In order to improve this tightness, it has been devised to split each profile into two distinct upper and lower elements, and to entangle them. The lower element has a global U-shape, the side arms of each lower element extending laterally and resting on each side on a guide rail, also with a global U-shape. The upper element has an inverted U-shape, the arms of an upper element encasing within the space of two juxtaposed lower elements. Thus, the upper element covers the gap between said two lower elements.

Though this technique permits to improve the conferred tightness between the elements, the entanglement of the floor dissociates the blades, making its manufacture more complex. In addition, the elements have complex and accurate shapes, which also make manufacturing more complex and increases the inherent costs.

In this context of a tray having a moving floor, the tightness must be particularly respected in the case of a ventilation carried out through said tray. It consists in causing a fluid, preferably air, namely heated air, to circulate by passing through the blades of the movable floor. Such a ventilation may be necessary when transporting a load to be dried, for example such as wood chips.

To this end, each blade has, regularly distributed over its length and at the level of its lower face, openings communicating with an underlying air circuit, so that the air passes through and penetrates into each blade. In addition, the upper face of each blade has orifices ending so as to permit that the air enters into contact with the load supported by said floor.

In order to simplify the manufacture of the blades, a perforated cover plate is applied and fastened to a generally U-shaped lower longitudinal beam. In particular, said plate is offset at one side, resting on each upper edge of said longitudinal beam and protruding so as to rest on the edge of an adjacent blade and to cover the gap between the two adjacent blades.

The fastening of the plate to the longitudinal beam of a same blade occurs by screwing at regular intervals or by welding over all or part of the length of said longitudinal beam and said cover plate. In either case, these methods for fastening result into local deformations of said plate, altering its flatness. Now, this flatness ensures the tightness of the gap between two juxtaposed blades, as well as the sliding movement, the cover plate of a blade resting and sliding on one of the edges of the longitudinal beam of the adjacent blade.

### BRIEF SUMMARY OF THE INVENTION

The aim of the present invention is to cope with the drawbacks of the state of the art by providing an alternative and simplified design of a loading tray device having a movable, preferably ventilated floor. To this end, it has been devised to shorten the width of the cover plate and to let a first edge of the longitudinal beam of a first blade rest directly on the adjacent edge of the longitudinal beam of a second juxtaposed blade. Said first edge has thus been widened, so as to form a flange covering the gap between said first and second blades and to rest on said adjacent edge.

Moreover, in order to preserve the overall flatness of the floor, the height of the adjacent edge intended to receive by resting on it the edge of a longitudinal beam of a juxtaposed blade has been reduced.

Thus, with such an assembly, the deformation associated with the fastening of the cover plate has in no way any influence on the tightness between two blades, the contact area of which retains its perfect flatness. In addition, the sliding of two blades with respect to each other occurs directly through their longitudinal beam, improving the sliding and limiting the wear over time.

In order to obtain an improved flatness, such a device comprises blades the longitudinal beams of which are made from sheets that are only bent. This manufacturing by folding permits to obtain an improved accurateness and a perfect linearity of the edges and flanges, ensuring their contact and the so imparted tightness.

To this end, the present invention relates to a loading tray device having a movable floor, comprising a frame receiving a juxtaposition of at least a first and a second blade mounted in longitudinal translation, each blade being formed, on the one hand, of at least one lower longitudinal beam provided with a bottom above which are mounted a first and a second sidewall and, on the other hand, by at least one cover plate for said longitudinal beam fastened to the upper edges of said sidewalls, wherein said first and second walls mutually comprise a first and a second flange extending laterally and externally with respect to said longitudinal beam, and said second wall of each blade has a height that is less than that of said first wall by the thickness of the first flange, so that said first flange of said second blade rests on said second flange of said first blade.

In addition, according to further additional, non-restrictive features, said plate may comprise in its lower portion raising means at the level of the upper edge of said second wall of each blade.

Said raising means may be in the form of at least one slat having a thickness equivalent to the thickness of said first flange, each slat being fastened on the lower face to the second edge and on the upper face to said plate of its blade.

Each longitudinal beam of each blade, its sidewalls, its edges and its flanges can be obtained by folding a sheet.

Furthermore, the loading tray device according to the invention may provide for being ventilated. To this end, it includes at least one opening passing through the bottom of said longitudinal beam of at least one of said blades and orifices passing through at least its cover plate.

### BRIEF DESCRIPTION OF THE SEVERAL VIEWS OF THE DRAWINGS

Further features and advantages of the invention will become clear from the following detailed description of non-restrictive embodiments of the invention, with reference to the attached figures.

FIG. 1 is a partial perspective view of an example of a tray device having a movable floor, in the case in which it is ventilated, showing the cross-sections of a plurality of juxtaposed blades mounted slidably with respect to each other, the blades at the right covering the blades at the left.

FIG. 2 is another partial perspective view of a single blade of FIG. 1.

FIG. 3 is a vertical cross-sectional view of FIG. 2.

### DETAILED DESCRIPTION OF THE INVENTION

The present invention relates to a loading tray device having a movable floor 1.

Such a device 1 comprises a frame (not shown), serving as a support for said movable floor. Such a frame receives a juxtaposition of at least a first 2 and a second 3 blades. Preferably, blades are positioned adjacent the entire width of said device 1 and are supported at the upper face of said frame.

In addition, said blades 2, 3 are mounted in longitudinal translation, i.e. they slide together or separately from each other. Said first blade 2 belongs to a first group of blades, while said second blade 3 belongs to a second group of blades, each group being jointly or separately actuated in translation. An additional group of blades may be provided, also actuated simultaneously with the other groups, together with either of the other two groups, or fully independently from each of the other groups of blades.

In addition, said device 1 comprises actuating means made integral with the lower face of each blade 2, 3, preferably of each of the blades per group of blades of said floor, in order to provide it with its mobility.

On the one hand, each blade 2, 3 is formed of at least one lower longitudinal beam 4. The latter is provided with a bottom 40, above which are mounted a first 5 and a second 6 sidewall. Preferably, these walls 5, 6 extend orthogonally with respect to said bottom 40, parallel to each other, along its longitudinal sides. Thus, the longitudinal beam 4 has a global U-shape, forming a hollow tank open at the upper face.

On the other hand, each blade 2, 3 is formed of at least one plate 7 for covering said longitudinal member 4. This plate 7 closes the opening at the upper face of said longitudinal beam 4. It is fastened to the upper edges 8, 9 of said sidewalls 5, 6. In other words, the plate 7 is applied on the top and fastened to the top of the walls 5, 6 in order to close the space between them. The longitudinal beam 4 then has a globally rectangular cross-section and is similar to a rectangular parallelepiped.

The fastening can occur in any way, preferably by welding or screwing, even by means of rivets. Preferably, this fastening provides a hermetic contact, ensuring the tightness between the longitudinal beam 4 and the plate 7.

Advantageously, said first 5 and second 6 walls mutually comprise a first 10 and a second 11 flange. The latter extend laterally and externally with respect to said longitudinal beam 4, on both sides of their respective wall 5, 6. In other words, said flanges 10, 11 extend parallel to the bottom 40, forming wings on either side of the longitudinal beam 4.

In addition, said second wall 6 of each blade 2, 3 has a height that is less than that of said first wall 5. The first flange 10 is then located higher than the second flange 11.

This difference in height is by the thickness of the first edge. In other words, the height of the second wall 6 is equivalent to the height of the first wall less the thickness of said first flange 10.

Thus, for two adjacent blades 2, 3, said first flange 10 of said second blade 3 rests on said second flange 11 of said first blade 2. In brief, the second blade 2 lies above said first blade 3.

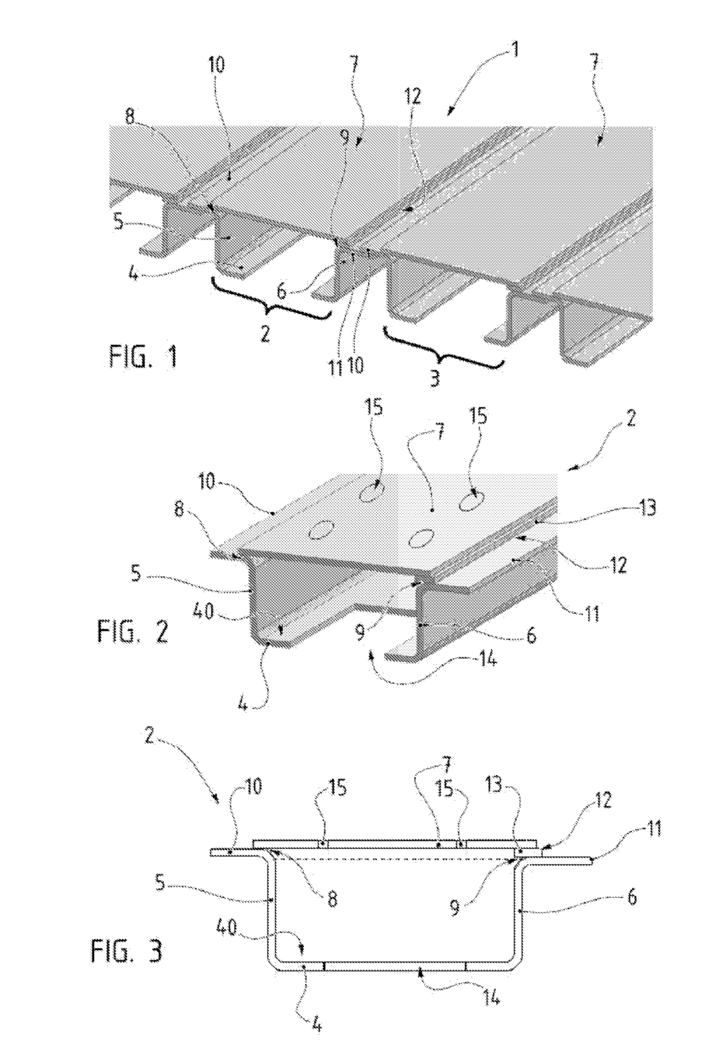

In the example shown in FIG. 1, the second blade 3 is positioned at the right and covers the second flange 11 of the first blade 2 located at the left.

Therefore, it should be noted that the respective width of the first and second flanges 10, 11 is dimensioned so as to permit to cover the gap between the juxtaposed blades 2, 3 and to ensure the resting of the first flange 10 of the second blade 3 on the second flange 11 of the first blade 2 over a sufficient distance, namely in order to ensure a contact area sufficient to impart the tightness between the lower face of the second flange 11 and the upper face of the first flange 10, as well as to permit a good sliding of same with respect to each other.

According to an additional, non-restrictive feature, in order to ensure the flatness of the assembly of the movable floor, said plate 7 comprises at the lower side raising means 12 at the level of the upper edge 9 of said second wall 6 of each blade 2, 3. Indeed, since the first flange 10 is higher than the second flange 11 of the same longitudinal beam 4, it is necessary to compensate for this difference in level, so that the plate 7 is parallel to the bottom 40, preferably horizontal. It is therefore necessary to add a height equivalent to the thickness of said first flange 10.

According to the preferred embodiment, said raising means 12 are in the form of at least one slat 13 having a thickness equivalent to the thickness of said first flange 10. This slat 13 is therefore interposed between the bottom of the plate 7 and the top of the second edge 6. Each slat 13 is fastened at the lower face to the second edge 6 and at the upper face to said plate 7 of its blade 2, 3. This fastening preferably occurs in a tight way, but not necessarily in the case of a ventilated floor. Several slats 13 may be abutted over the entire length of a blade 2, 3 in order to ensure the raising and flatness of the plate 7.

According to an alternative embodiment, not shown, the longitudinal edge of the plate 7 can be folded so as to comprise a downward set-back of the height necessary to compensate for the difference in level and the difference in height between the first 10 and the second 11 flange.

According to a preferred additional feature, as can be seen in the figures, each longitudinal beam 4 of each blade 2, 3, its sidewalls 5, 6, its edges 8, 9 and its flanges 10, 11 are obtained by folding a sheet. This folding technique permits to obtain a perfect flatness of the longitudinal beam 4, in particular at the level of its edges 10, 11 that must cooperate with each other for two juxtaposed blades 2, 3, in tightest possible contact, by sliding. The folding of the same sheet also permits to ensure better rigidity of the longitudinal beam 4, in particular against bending over its length.

According to a preferred application, said movable floor equipping the device 1 is designed ventilated. This ventilation ensures the putting into circulation of a fluid, such as air, in particular heated air, from below to the top of said device 1. This putting into circulation occurs namely under the action of adapted ventilation means (not shown).

To this end, the floor includes at least one opening 14 passing through the bottom 40 of said longitudinal beam 4 of at least one of said blades 2, 3. Preferably, several openings 14 are provided for through the bottom 40, spaced over its length, whether at regular intervals or not.

In addition, said floor includes orifices 15 passing through at least its cover plate 7. These orifices are provided for through the thickness of said plate 7 and/or at the level of its junction with either one of the edges 8, 9. They are provided for over the length of the plate 7, whether at regular intervals or not.

It should be noted that the orifices 15 may be at least partially formed by separations at the level of the fastening of each slat 13, in particular the separation between the welding or screwing points, even a separation between two abutting slats 13.

Thus the air is put into circulation between the inside of each blade 2, 3 through the openings 14 and leaves above the device 1 through the orifices 15.

Due to the particular design of each of its blades 2, 3, with a longitudinal beam 4 obtained by the accurate folding of a sheet and shaped as a trough equipped with edges 10, 11 protruding laterally and offset in height, as well as with a plate 7 covering said longitudinal beam 4 and being fastened recessed at the level of its edges 8, 9 without altering the shape of said flanges 10, 11, the arrangement of the tray device 1 having a movable floor according to the invention provides an improved flatness and tightness.

1. A loading tray device comprising: a movable floor; a frame receiving a juxtaposition of at least a first and a second blade mounted in longitudinal translation, each blade being formed of at least one lower longitudinal beam provided with a bottom above which are mounted a first and a second sidewall and by at least one cover plate for said longitudinal beam fastened to the upper edges of said sidewalls, wherein said first and second walls mutually comprise a first and a second flange extending laterally and externally with respect to said longitudinal beam, and
wherein said second wall of each blade has a height that is less than that of said first wall by the thickness of the first flange, so that said first flange of said second blade rests on said second flange of said first blade.

2. The loading tray device, according to claim 1, wherein said plate comprises at the lower portion raising means at the level of the upper edge of said second wall of each blade.

3. The loading tray device, according to claim 2, wherein said raising means are in the form of at least one slat having a thickness equivalent to the thickness of said first flange, each slat being fastened on the lower face to the second upper edge and on the upper face to said plate of its blade.

4. The loading tray device, according to claim 1, wherein each longitudinal beam of each blade, its sidewalls, its edges and its flanges are obtained by folding a sheet.

5. The loading tray device, according to claim 1, wherein said movable floor is provided ventilated and to this end comprises at least one opening passing through the bottom of said longitudinal beam of at least one of said blades and orifices passing through at least its cover plate.
